(19) United States
(12) Patent Application Publication
(10) Pub. No.: US 2021/0241570 A1
(43) Pub. Date: Aug. 5, 2021

(54) APPARATUS FOR PLAYING A GAME

(71) Applicant: Big Time Gaming, Pty Ltd., Sydney (AU)

(72) Inventor: Nik Robinson, Sydney (AU)

(73) Assignee: Big Time Gaming, Pty Ltd., Sydney (AU)

(21) Appl. No.: 16/778,898

(22) Filed: Jan. 31, 2020

(51) Int. Cl. G07F 17/32; G07F 17/34

(52) U.S. Cl. CPC G07F 17/3213; G07F 17/34; G07F 17/3267; G07F 17/3265

(57) ABSTRACT

In an embodiment there is provided a game device including an input device; a display device operatively connected to a controller; the controller reading a non-transitory computer readable medium containing operative instructions where, in response to an input from an input device the controller causes the display device to display a representation of slot machine reels wherein matched game symbols exceeding a matching threshold value are removed revealing smaller game symbols available for game play.

### TECHNICAL FIELD

Embodiments of the invention generally fall into the category of game systems.

### BACKGROUND OF THE INVENTION

Gaming devices such as slot machines have achieved a predominant presence in the gaming industry. A measure of their success is attributable to the multiplicity of creative ways game providers use to provide an award to a player making a wager of value. In general, the popularity of such machines with players depends upon the perceived likelihood of winning money at the particular game and the intrinsic entertainment value of the game relative to other available gaming options. In addition, some players avoid some forms of slot machine games due to complex multi-line pay-outs which are difficult, but important, to understand in order to make an informed wager. Simply put, a game that is too complex decreases overall enjoyment as the ability for a player to understand how to win or place wagers is diminished by increased complexity.

When a player encounters a plethora of competing game choices and the options include a number of competing games with perceived similar expectations of winning, it is thought players are then most likely attracted to the most entertaining and exciting games in which the results are easy to understand and cognizable wagers may be placed. Thus, gaming operators seek out games that are the most entertaining, exciting, and simple to understand.

Contemporary slot machines are no longer limited to purely mechanical reels that spin with game symbols aligning to form a payline. Game devices now have a multiplicity of bonus games, bonus symbols, and other ways of winning or increasing an award, thus increasing the excitement for the player. Increasingly, such games are not only housed in traditional slot-machine-style enclosures but are also made available via internet gaming sites that allow a player to play remotely.

Since the excitement and entertainment value a game provides wanes over time due to player fatigue, there is an ongoing need to develop new features and methods of playing games. Coupled with an expansion of video wagering systems from systems requiring presence in a gaming house to remote systems played at home, there is a continuing need for innovative games and game devices that are playable both in-house and remotely.

### BRIEF SUMMARY OF THE INVENTION

In an embodiment there is provided a game device including: an input device; a display device operatively connected to a controller; the controller reading a non-transitory computer readable medium containing operative instructions where, in response to an input from an input device the controller causes the display device to display: a first game grid composed of subdividable grid elements arrayed in a series of rows and columns configured to support game symbols; populating the first game grid with a random selection of large game symbols; randomizing the positions of large game symbols via column rotation; matching a defined number of adjacent large game symbols across rows and columns; clearing adjacent matched large game symbols that exceed a matched clearance threshold from the large grid elements; increasing a match counter for each matched group exceeding a matched clearance threshold; subdividing the cleared large grid elements into a plurality of small grid elements configured to support small game symbols arrayed in a series of rows and columns said plurality contained within the space of the original large grid element; populating the small grid elements with small game symbols; randomizing the small game symbols via column rotation; matching the small game symbols across rows and columns additionally matching with large game symbols; clearing adjacent small and large game symbols that exceed a matched clearance threshold from the small grid elements; clearing matched large game symbols and subdividing cleared large grid element into cleared small grid elements; cascading small game symbols into the cleared small grid elements; repeating matching, clearing, populating, rotating, and cascading steps until no large or small game symbols match; awarding a prize based upon matched large and small game symbols.

In another embodiment there is provided a game device comprising: a display; a processing unit; a game controller operatively connected to the display, configured to facilitate interaction with a player and allow a player to place a wager in accordance with a predetermined paytable; a memory device that stores a plurality of different paytables for the game, each of the paytables including a plurality of awards and a plurality of respective outcomes associated with those awards, each said paytable having an average expected value associated with the plurality of awards and plurality of respective outcomes of said paytable, wherein a plurality of the average expected values are different; and a non-transitory computer-readable medium; and, wherein the display, processing unit, game controller, and memory device are operatively connected to each other in a configuration that enables a player to control and interact with a game stored on computer readable code in the non-transitory computer readable medium, said code configuring the controller to drive the display of: a game grid composed of large grid elements arrayed in a series of rows and columns configured to support large game symbols; populating the game grid with a random selection of large game symbols; randomizing the positions of large game symbols via column rotation; matching a defined number of adjacent large game symbols across rows and columns; clearing adjacent matched large game symbols that exceed a matched clearance threshold from the large grid elements; increasing a match counter for each matched group exceeding a matched clearance threshold; subdividing the cleared large grid elements into a plurality of small grid elements configured to support small game symbols arrayed in a series of rows and columns; populating the small grid elements with small game symbols; randomizing the small game symbols via column rotation; matching the small game symbols across rows and columns additionally matching with large game symbols; clearing adjacent small and large game symbols that exceed a matched clearance threshold from the small grid elements; clearing matched large game symbols and subdividing cleared large grid element into cleared small grid elements; cascading small game symbols into the cleared small grid elements; repeating matching, clearing, populating, rotating, and cascading steps until no large or small game symbols match; awarding a prize based upon matched large and small game symbols.

### BRIEF DESCRIPTION OF THE DRAWINGS

FIG. 01 illustrates a conceptual schematic of a game grid with subdividable grid elements that support game symbols.

FIG. 02 illustrates a conceptual schematic representation of a game grid with a plurality of game elements supporting game symbols illustrating an example matched configuration.

FIG. 03 illustrates a conceptual schematic representation of a game grid with a plurality of game elements supporting game symbols illustrating a cascading game symbol.

FIG. 04 is comprised of successive illustrations of a display device configured to display an example of game play according to an embodiment of the invention.

FIG. 05 is comprised of successive illustrations of a display device configured to display an example of game play according to an embodiment of the invention.

FIG. 06 is comprised of successive illustrations of a display device configured to display an example of game play according to an embodiment of the invention.

FIG. 07 is comprised of flow chart demonstrating a method of gameplay according to an embodiment of the invention.

FIG. 8 illustrates a general schematic block diagram of an electronic configuration of a game device configured to play embodiments of the above game.

### DETAILED DESCRIPTION OF THE INVENTION

Although described in the context of a slot machine, it is understood that in addition to a physical apparatus, analogous elements of the game device may also be formed on a display device. For example, the term “reel” as used herein refers not only to the physical “reel” of a slot machine but also to a display device configured to display an analogous column of grid elements that are part of a game grid where grid elements configured to support game symbols are arrayed in a series of rows and columns. An example embodiment is a game device in the form of a slot machine having the controls, displays, and features of a conventional slot machine, including rotating reels. It is constructed so that a player can operate it while standing or sitting and the gaming device is preferably mounted on a console or cabinet. It is appreciated, however, that the gaming device can be constructed as a pub-style table-top game which a player can operate while sitting. Furthermore, the gaming device can be constructed with varying cabinet and display designs.

In another embodiment, the game device can be implemented as a program code stored in a non-transient computer-readable medium configured to connect to a computer controller further operably connected to a display device, said code configuring the controller to drive the display of the game, the methods for playing embodiments of the game further described below. The display screen may be embedded in the form of slot machine cabinets as described above or may be a part of a laptop/desktop/projector or other video display system.

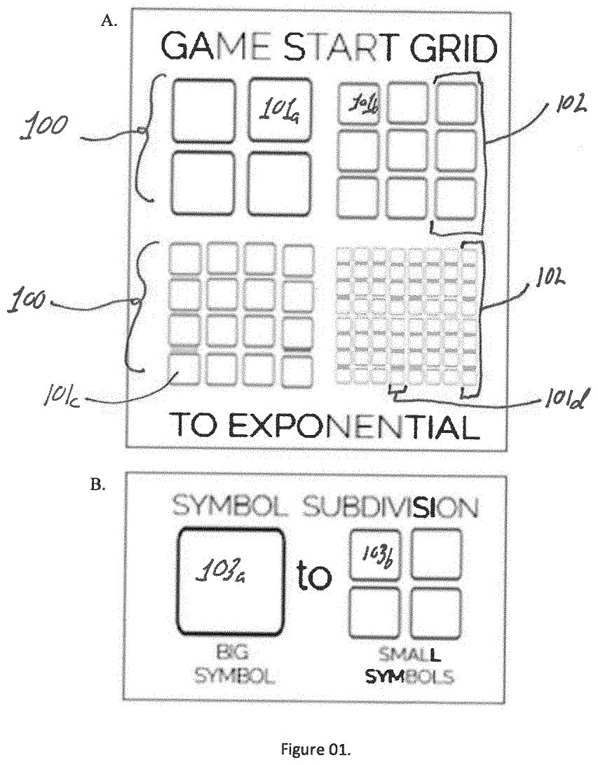

FIG. 1A illustrates conceptual schematic examples of game grid 100 configurations. As used herein a “game grid” refers to grid elements 101 (a class of elements with sub-elements denoted a, b, c, etc.) arrayed in a series of rows and columns; although illustrated as a 2 dimensional grid similar to graph paper, it is expressly contemplated that a grid may be formed in a physical space by, for example, applying grid elements 101 over the circumferential perimeter of a reel of a slot machine. In such a game grid, columns 102 of grid elements, either physically applied to a reel, or in a representational space may be rotated either physically as part of a reel or representationally on a display device by a “column rotation” effect wherein the movement of game symbols across grid elements creates the illusion of a spinning reel.

Grid elements 101 are subdividable from large grid elements to small grid elements. As used herein the terms “large,” “big,” and “small” are taken in reference to size changes of analogous elements (e.g., grid elements or game symbols, etc.) and are not prescriptive of specific sizes or ratios other than in relationship to an analogous item. By way of non-limiting illustrative example, as shown in FIG. 1A: As part of a game grid 100, grid elements 101 subdivide from larger grid elements 101a to a smaller, greater, number grid elements 101b within game grid 100. Game element 101a, may undergo multiple subdivisions at once to smaller size 101c or 101d directly. In some instances the game grid 100 may remain the same size as grid elements 101 alter in size, in other embodiments, the game grid 100 may increase or decrease in size (defined as a change in area, as in on a display device, or by the addition or subtraction of playable reels in a physical slot machine) in relation to alterations of the size or number of grid elements and corresponding game symbols.

Likewise, as shown in the conceptual schematic example of FIG. 1B, a game symbol 103 (a class of elements with sub-elements denoted a, b, c, etc.), typically supported or contained within a grid element (not shown) may also subdivide or be replaced from larger 103a to smaller 103b or recombine from small 103b to large 103a symbols.

As used herein the term “game symbol” refers to both a physical token, such as a printed card bearing an image mounted on a reel, or a digital representation thereof. Commonly found game symbols include gems in various shapes, colors, and facet numbers; fruits such as cherries, bananas, and apples; animals such as eagles, bears, and wild cats; and, any other manner of representational symbology. According to rules, game symbols may be matched with each other to trigger events within the game.

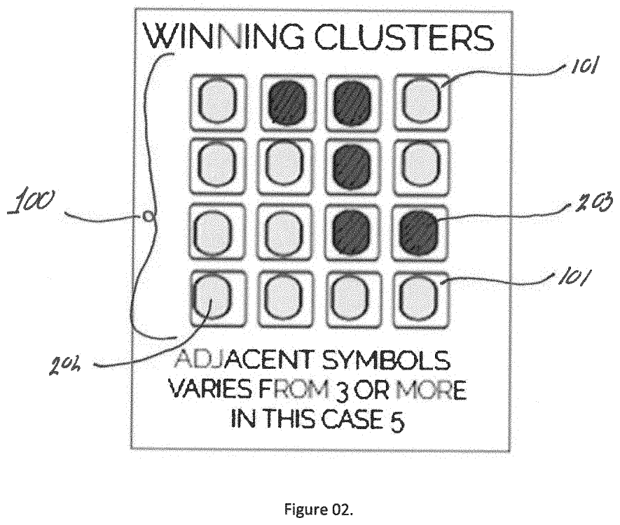

FIG. 2 illustrates a conceptual schematic of a game grid 100 with grid elements 101 supporting two types of game symbols 202 and 203. Game symbols 202 are random symbols that do not match according to the rules of game play. Game symbols 203 are symbols of the same type or class that constitute a “match.” For example, game symbols 203 may be all blue triangular gems, or yellow octagonal gems. In some embodiments a “match” may incorporate one or more “wild” symbols. As used herein, “wild” symbols are those that, although they do not match a symbol nevertheless enable a match to be made with one or more matching symbols that otherwise would not exceed a matching threshold value. For example, if a matching threshold value of three (3) symbols is required and two symbols match, a third wild symbol, may be incorporated into the matching symbols count, thus exceeding the matching threshold value and triggering the next step of gameplay. When incorporated into a matched group of symbols that exceeds a matching threshold value the wild symbol may also trigger additional elements of game play such as, in the case of a slot machine, extra spins of the reels for extra chances to win, an increase to a prize multiplier, or the triggering of an additional bonus game allowing for enhanced prizes or awards.

In an embodiment of the invention, matched game symbols exceeding a matching threshold value, with or without incorporated wild symbols, are cleared from their respective grid elements, leaving them open. As part of clearing the game symbols, various auditory and visual effects may be played both during the clearance and then, afterward, as game symbols are repopulated into grid elements.

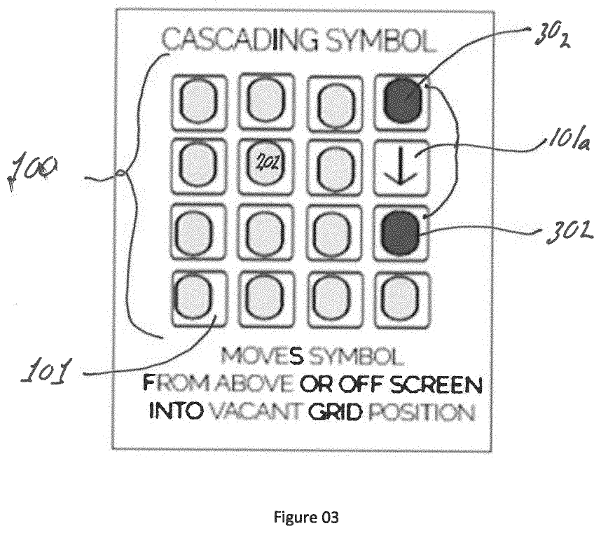

FIG. 3 illustrates a conceptual schematic of a game grid 100 with grid elements 101 supporting game symbols 202. Empty grid elements 101a are filled by replacement game symbol 302 which moves from an initial position at the top of a column and transitions through empty grid elements 101a to a final grid element characterized as an empty grid element above a grid element occupied by a game symbol or a grid element that is part of the last row in game grid 100. In another example, should game symbols be cleared from the middle of a game grid, game symbols 202 above the cleared grid element move downwards to fill the cleared grid elements with uppermost grid elements made vacant by downward game symbol movement repopulated in a random fashion. Thus, in this fashion, a “cascade” of game symbols fills empty grid elements repopulating the game grid with new game symbols.

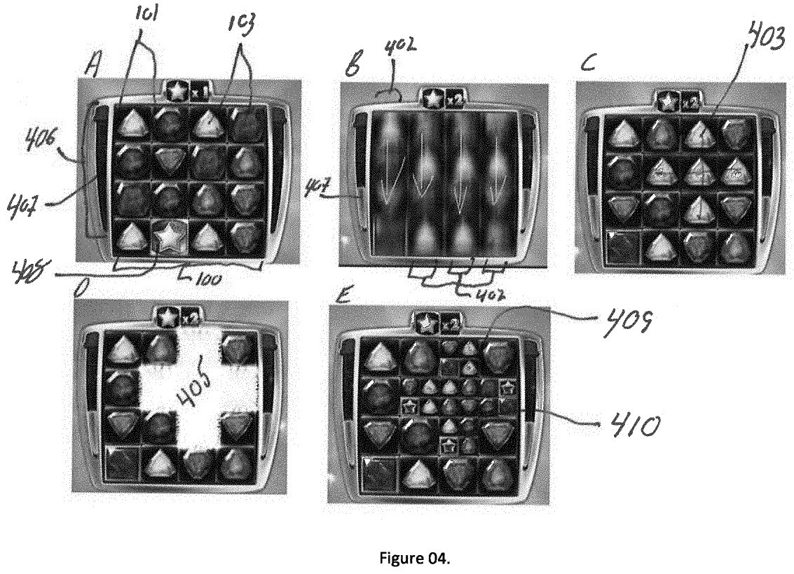

FIG. 04 comprises successive illustrations of a display device configured to display an example of game play according to an embodiment of the invention. FIG. 4A illustrates an initial starting position of a game grid 100 with grid elements 101 configured in 4 rows×4 columns. The grid elements 101 are populated with a random assortment of game symbols 103 including a wild symbol 408. Adjacent to the game grid 100 are win/match counters 406 composed of individual counter segments 407. Illumination of individual counter segments 407 within the win/match counters 406 serve as an indicator/reminder to the player of the number of wins/matches achieved within the rules and current stage of game play.

FIG. 4B illustrates, after receiving input from a player via a controller configured to interface with the apparatus and to relay player inputs, the imposition of a rotational effect on columns of grid elements 402. In this instance the columns are rotated downward. Rotation of the columns may also occur in an “upwards” direction. Columns/reels that are rotating are not required to spin at the same rates or in the same directions as adjacent columns, or other columns/reels that form a portion of game grid 100. Although the rotational effect is described in terms of vertically oriented reels and columns, it is anticipated that rows could also be rotated in similar fashion through the use of horizontally oriented reels or a similar “row rotation” effect.

FIG. 4C illustrates the state of the game grid 100 after imposition of the column rotation effect. In this instance matching game symbols 403 exceeding a matching threshold value are found in the form of a cross shape. A first counter segment 407 is illuminated. As illustrated in FIG. 4D matching game symbols 403 are cleared from grid elements 101 via an explosion effect 405. It is anticipated that any other type of effect, such as vanishing, moving away, removal of tokens from reels, etc. may also serve equally well to remove game symbols 403 from game grid 100. Simultaneous to the explosion effect 405, the emptied grid elements are subdivided once into smaller grid elements 409 in the positions formerly held by larger grid elements 101 of the initial state, thus, what was once one column and one row is now two columns and two rows repopulated with smaller game symbols 410 as illustrated in FIG. 4E. En other embodiments more than one subdivision may occur resulting in the creation of greater numbers of smaller grid elements supporting smaller game symbols. In the configuration shown in FIG. 4E there are no matching game symbols above a matching threshold value. Game play would stop and a prize based on the amount of matches, with or without the benefit of any multiplier value (sometimes varied by use of wild symbols) is awarded. In some embodiments the awarded prize is one of monetary value either in representational (virtual points, chips, tokens, etc.) or hard currency (cash value, coins, bills, etc.) Alternatively, the prize awarded may be additional “spins” of the reels starting from an initial game state as shown in FIG. 4A. Alternatively, if a player was awarded bonus level spins, a bonus round of play may subsequently initiate (discussed below). Play ends if a player has no more matches, no more spins, no more bonus spins, no more wagers, or any other defined end state.

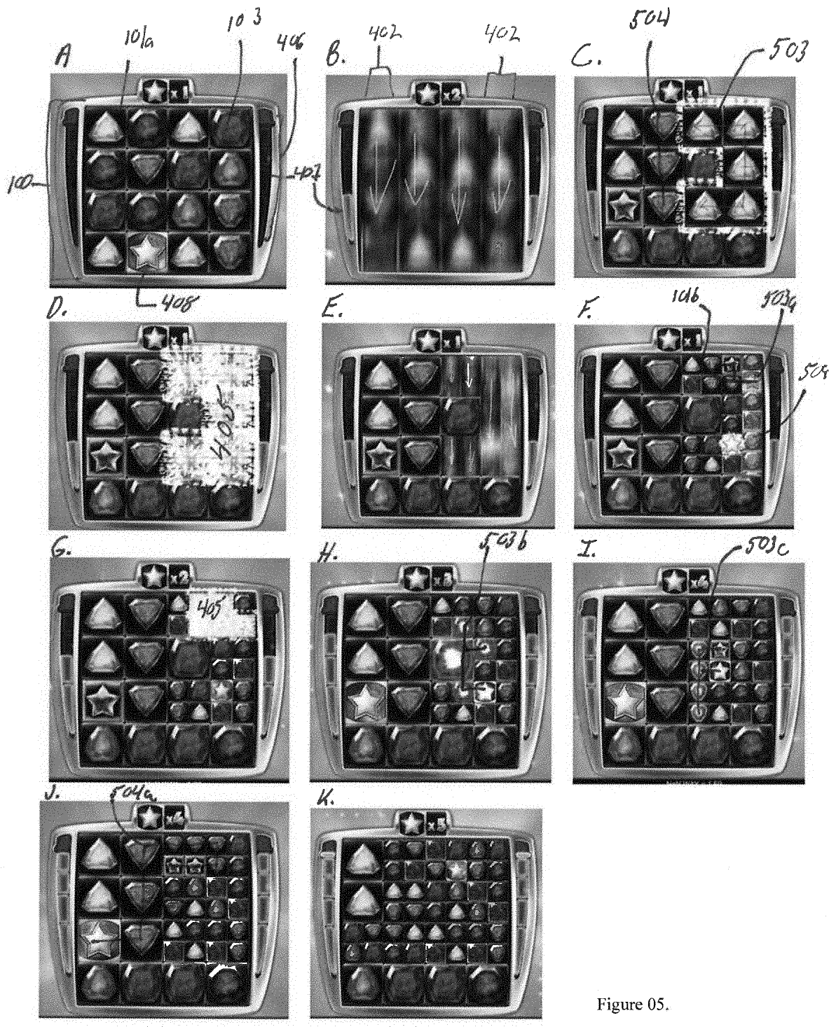

FIG. 05 comprises successive illustrations of a display device configured to display an example of game play according to an embodiment of the invention. Similar to FIG. 4A, FIG. 5A illustrates an initial starting position of a game grid 100 with grid elements 101 configured in 4 rows×4 columns. The grid elements 101 are populated with a random assortment of game symbols 103 including a wild symbol 408. Adjacent to the game grid 100 are win/match counters 406 composed of individual counter segments 407. The game is initiated by player input which may also include the input of a wagered amount.

Shown in FIG. 5B, similar to FIG. 4B, is illustrated the step of, after receiving input from a player via a controller configured to interface with the apparatus and to relay player inputs, the imposition of a rotational effect on columns of grid elements 402.

Similar to FIG. 4C, FIG. 5C illustrates the state of the game grid 100 after imposition of the column rotation effect. In this instance a first set of matching game symbols 503 exceeding a matching threshold value are found in the form of a backwards “C” shape formed by three vertically adjacent matching symbols and two horizontally adjacent matching symbols. Also found is a second set of matching game symbols 504 in the shape of a line of three matching symbols. A first counter segment 407 is illuminated. As illustrated in FIG. 5D, similar to FIG. 4D, the first set of matched symbols 503 are cleared from their grid elements via explosion effect 405. Shown in FIG. 5E the initial large grid elements 101a from matching large game symbols 503 are subdivided into smaller grid elements 101b and new game symbols are populated into the grid elements via column rotation.

Illustrated in FIG. 5F, the smaller game symbols 503a, form a matching configuration exceeding a matched value threshold including a wild symbol. Illustrated in FIG. 5G the matched game symbols are cleared via an explosion effect 405. Additional win/match counters 407 are illuminated. New symbols are cascaded into place resulting in the game grid 100 configuration illustrated in FIG. 51-1 which contains a new matching set of large and small game symbols 503b. The matching large and small game symbols 503b are cleared, the large grid element is sub-divided into smaller grid elements and the small grid elements are repopulated with small game symbols either by column rotation, cascade effect, or both, the result of which is illustrated in FIG. 51 with a new winning cluster of matched game symbols 503c in the shape of a line of four matched game symbols and two adjacent wild symbols. Matched symbols 503c are cleared. No additional subdivisions of grid elements are performed and game symbols are repopulated via cascade or column rotation effect into the configuration illustrated in FIG. 5J. Appropriate win/match counters are illuminated. FIG. 5J illustrates the result of the operations which created a new matched configuration of 11 matched game symbols 504a which include matched game symbols 504 previously created and 3 wild symbols. Matching game symbols 504a are cleared and win/match counters 406 are incremented resulting in the game grid 100 configuration illustrated in FIG. 5K. The steps of matching, clearing, repopulating, and paying wins are successively iterated until such time as no more matches can be made and all subsequent spins, “free spins,” or “bonus spins” are exhausted. Game play ceases and final winnings are paid.

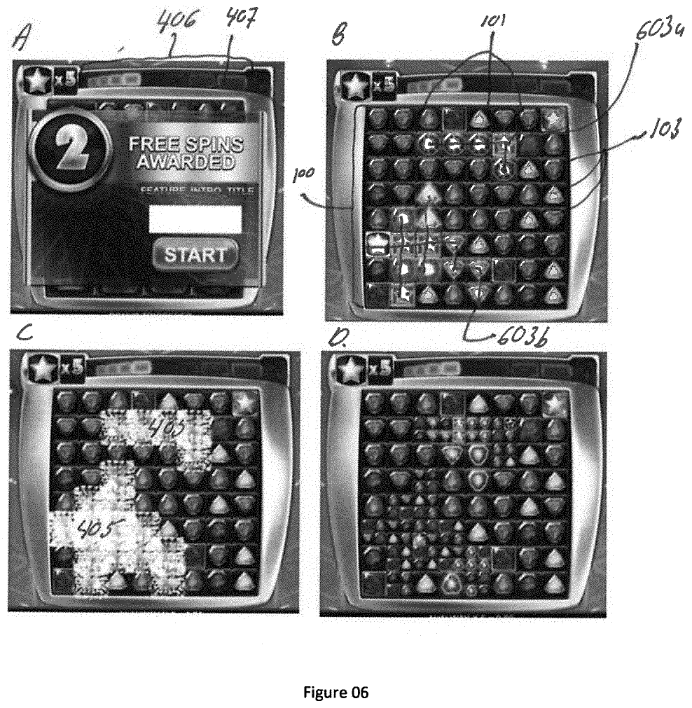

In certain embodiments, as illustrated in FIG. 6A, the display is further configured to show an additional bonus game initiated as a result of wins or matches obtained in prior rounds of gameplay. As shown in FIG. 6B, game grid 100 is divided into an initial configuration of 8×8 game grid elements 101 randomly populated as described above with game symbols 103. As shown two sets of matched symbols exceeding a matching threshold value, 603a and 603b, are present in the initially populated set of game symbols. Matched symbols 603a and 603b are cleared via explosion effect 405 as described above and illustrated in FIG. 6C. As described above, cleared grid elements 101 are subdivided into smaller grid elements subsequently repopulated with smaller game symbols. Matching, clearing, and repopulation steps are repeated, with appropriate wins/prizes awarded at each stage. FIG. 06A-D also illustrates a win/match counter 406 with counter segment 407. The win/match counter 407 is incremented according to the number of matches or winning states achieved. Prizes and/or winnings may be awarded with each match set or at the end of each round of play. As above, play of the bonus round ceases when no further matches can be made, and a player has exhausted all awarded spins, free spins, or bonus spins.

Prizes and/or winnings may be further adjusted by multiplier values. For example, a wild game symbol may increase the multiplier by 1 every time it occurs in a win. If multiple wild game symbols occur on a win then the multiplier value is set as the multiplied value of the wild game symbol. For example, if a first wild game symbol has a multiplier value of seven (7) and a second of the same type of symbol appears in a win then the pay value for the win is multiplied by 49. In some embodiments, sizes of wins are determined by the number of matched game symbols (such as those illustrated by elements 203, 403, 503, 503a, 503b, 503c, 504, 504a, and 603a and 603b found in their respective figures) and the total number of matched clusters cleared. More symbols and more clusters of matched symbols cleared lead to higher winnings further calculated based upon an initial wagered amount. In other embodiments, winnings may be awarded solely on matches made, in any orientation, rather than based on the number of match clusters cleared.

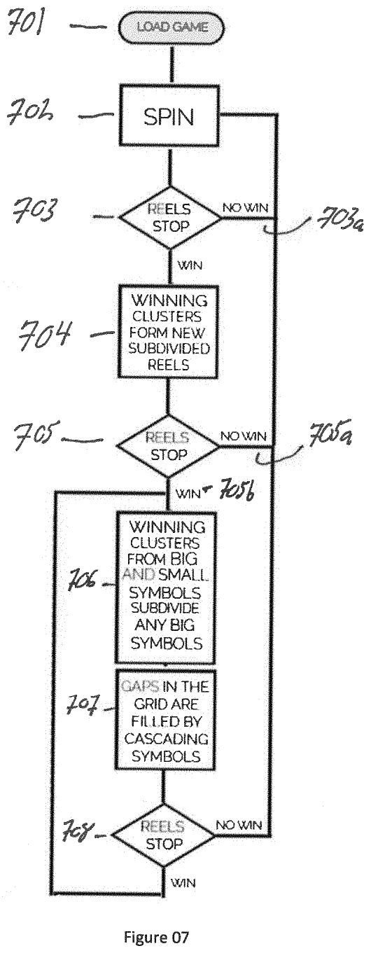

FIG. 7 illustrates an example flowchart of gameplay according to an embodiment of the invention. The game is set to an initial loaded state 701. The columns/reels are then spun and/or a column rotation effect is applied 702. The reels stop and matching game symbols exceeding a match threshold value are determined 703. If there is no win game play ceases 703a. If there is a win matched game symbols/clusters of game symbols are cleared from the game grid, the game grid elements are subdivided and repopulated as described above with either column rotation, cascading symbols, or a combination of both 704. The reels/effects stop rotation/cascading and matched game symbols and clusters are determined 705. If a no-win state is determined, play ceases 705a. If a win state is determined 705b matched symbols are cleared, cleared large grid elements are subdivided into small grid elements repopulated with small game symbols 706 with cascading symbols filling in empty grid elements as previously described 707. The reels stop and a win state is determined 708. If there is no win, game play ceases 708. If there is a win game play resets to step 705b and reiterates until a final no-win state is achieved. Winnings or prizes are then awarded as previously described.

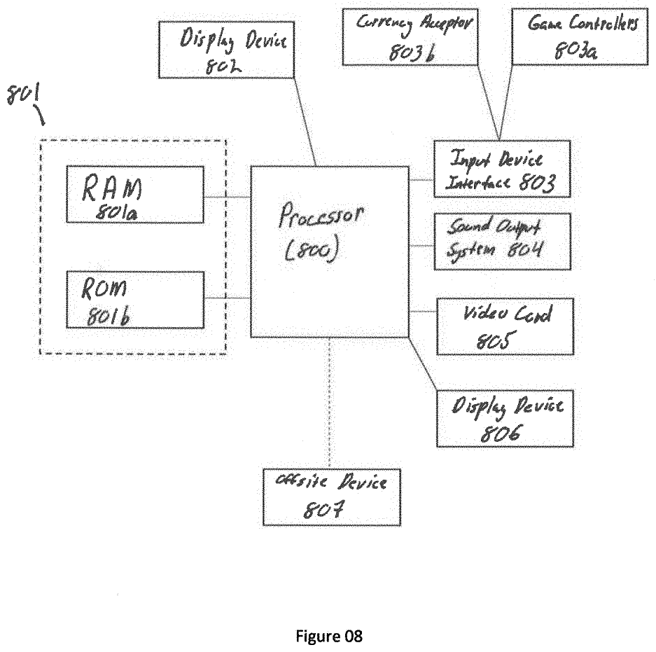

FIG. 8 illustrates a general schematic block diagram of an electronic configuration of a game device configured to play embodiments of the above game. The game device may comprise: a processor 800, a memory device 801 for storing program code or other data; a display device 802 as described above; and one or more input device interfaces 803. The system may further comprise: a sound output system 804 comprising a sound card, speakers, headphone jack, and other means to drive sound output; one or more video cards configured to drive at least one display 805, and additional display units 806.

The processor 800 is typically a microprocessor or microcontroller-based platfor which is capable of displaying images on a display device 200 of game symbols, creating and representationally displaying a game grid 100 and game grid elements 101 and various other components of the game. The memory device 801 can include random access memory (RAM) 801a for storing event data or other data generated or used during a particular game. The memory device can also include read only memory (ROM) 801b, or other non-transitory computer-readable media configured to store program code which controls the game device so it plays a particular game in accordance with applicable game rules and pay tables.

It should be appreciated that although a processor and memory devices are possible implementations, further embodiments can also be implemented using one or more application-specific integrated circuits (ASIC's) or other hard-wired devices, or using mechanical devices (collectively, and/or individually referred herein as a “processor”). Furthermore, although the processor and memory device in certain embodiments reside on each gaming device unit, it is possible to provide some or all of their functions from an off-site device 807 such as a network server for communication to a playing station such as over a local area network (LAN), wide area network (WAN), Internet connection, microwave link, and the like. The processor and memory device are generally referred to as a “computer” or “controller.”

Input devices 803, can include physical buttons and controllers such as joysticks, mice, keyboards, and similar game controllers 803a. Further, an input device can include specialized devices such as a currency acceptor 803b configured to relay the input of value to the processor. Examples can include devices that: take in bills or coins, read credit cards, take contactless payments, or any other means of taking an item of worth and conveying the value of said worth to the processor 800. Physical buttons may be symbolically represented on a display device 802, 806 configured to display input information. The display device 802 may further be configured to directly accept input from a user, as in a touch screen device or infrared screen overlay device. In further embodiments, additional value data may be obtained from a networked device configured to obtain value data and provide it to a processor.

Finally, the written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

What is claimed is:

1. A game device comprising:
an input device;
a display device operatively connected to a controller;
the controller reading a non-transitory computer readable medium containing operative instructions where, in response to an input from an input device the controller causes the display device to display:
a first game grid composed of subdividable grid elements arrayed in a series of rows and columns configured to support game symbols;
populating the first game grid with a random selection of large game symbols;
randomizing the positions of large game symbols via column rotation;
matching a defined number of adjacent large game symbols across rows and columns;
clearing adjacent matched large game symbols that exceed a matched clearance threshold from the large grid elements;
increasing a match counter for each matched group exceeding a matched clearance threshold;
subdividing the cleared large grid elements into a plurality of small grid elements configured to support small game symbols arrayed in a series of rows and columns said plurality contained within the space of the original large grid element;
populating the small grid elements with small game symbols;
randomizing the small game symbols via column rotation;
matching the small game symbols across rows and columns additionally matching with large game symbols;
clearing adjacent small and large game symbols that exceed a matched clearance threshold from the small grid elements;
clearing matched large game symbols and subdividing cleared large grid element into cleared small grid elements;
cascading small game symbols into the cleared small grid elements;
repeating matching, clearing, populating, rotating, and cascading steps until no large or small game symbols match;
awarding a prize based upon matched large and small game symbols.

2. The game device claim 1 further comprising: rendering columns of the game grid to the appearance of a slot machine reel.

3. The game device of claim 1 further comprising: wherein the matched clearance threshold consists of a minimum of three game symbols matched at least one of horizontally and vertically.

4. The game device of claim 1 further comprising: wherein subdividing the cleared large grid elements results in at least four small grid elements per space previously occupied by a large grid element.

5. The game device of claim 1 further comprising: an audio output device in addition to the display device through which are played at least one of a musical and video cue when large or small game elements are matched above the matching threshold.

6. The game device of claim 1 further comprising: wherein the controller is further configured to drive the display device to display: providing a player with a pre-set number of chances to repopulate the game grid; and,
wherein, upon reaching a point where no large or small game symbols match, allowing a player to repopulate the game grid with large game symbols via column rotation, starting a new cycle of game play.

7. The game device of claim 6 further comprising: configuring the controller to drive the display device to display a cessation of gameplay when no symbols match and no chances to repopulate the game grid remain.

8. The game device of claim 1 further comprising: configuring the controller to drive the display device to further display increasing the prize based upon the at least one of the number and type of matched game symbols.

9. The game device of claim 1 further comprising: through an input device, placing a wager before a matching sequence is initiated.

10. The game device of claim 9 further comprising: configuring the controller to drive the display device to display: incorporating an amount wagered by a player into calculating a prize awarded based on matched large and small game symbols.

11. The game device of claim 1 further comprising: configuring the controller to drive the display device to display removing a predetermined number of game symbols from the game grid when a special symbol is incorporated into a matched set of large or small game symbols.

12. The game device of claim 11 further comprising: through an audio output and display device playing at least one of an explosion or vanishing effect when removing the predetermined number of game symbols.

13. The game device of claim 1 further comprising: configuring the non-transitory computer-readable medium to configure the controller to determine the odds of awarding a prize are predetermined by a paytable.

14. The game device of claim 1 further comprising: configuring the controller to drive the display device to display initiating a bonus game when the match counter reaches a predetermined value.

15. The game device of claim 1 further comprising: wherein the first game grid is composed of large grid elements initially arrayed in 4 rows by 4 columns with subdivided smaller grid elements potentially arrayed, if all large game symbols are cleared, into 8 rows by 8 columns.

16. The device of claim 15 further comprising: wherein the controller is part of a computer system operatively connected to the Internet, the controller further configured to receive game instructions from the Internet.

17. The device of claim 15 further comprising: wherein the controller is part of a computer system integrated into a video slot machine interface.

18. A device comprising:
a display;
a processing unit;
a game controller operatively connected to the display, configured to facilitate interaction with a player and allow a player to place a wager in accordance with a predetermined paytable;
a memory device that stores a plurality of different paytables for the game, each of the paytables including a plurality of awards and a plurality of respective outcomes associated with those awards, each said paytable having an average expected value associated with the plurality of awards and plurality of respective outcomes of said paytable, wherein a plurality of the average expected values are different; and
a non-transitory computer-readable medium; and,
wherein the display, processing unit, game controller, and memory device are operatively connected to each other in a configuration that enables a player to control and interact with a game stored on computer readable code in the non-transitory computer readable medium, said code configuring the controller to drive the display of:
a game grid composed of large grid elements arrayed in a series of rows and columns configured to support large game symbols;
populating the game grid with a random selection of large game symbols;
randomizing the positions of large game symbols via column rotation;
matching a defined number of adjacent large game symbols across rows and columns;
clearing adjacent matched large game symbols that exceed a matched clearance threshold from the large grid elements;
increasing a match counter for each matched group exceeding a matched clearance threshold;
subdividing the cleared large grid elements into a plurality of small grid elements configured to support small game symbols arrayed in a series of rows and columns;
populating the small grid elements with small game symbols;
randomizing the small game symbols via column rotation;
matching the small game symbols across rows and columns additionally matching with large game symbols;
clearing adjacent small and large game symbols that exceed a matched clearance threshold from the small grid elements;
clearing matched large game symbols and subdividing cleared large grid element into cleared small grid elements;
cascading small game symbols into the cleared small grid elements;
repeating matching, clearing, populating, rotating, and cascading steps until no large or small game symbols match;
awarding a prize based upon matched large and small game symbols.

19. The device of claim 18 further comprising: wherein the controller is part of a computer system operatively connected to the Internet, the controller further configured to receive game instructions from the Internet.
